(19) United States
(12) Patent Application Publication
(10) Pub. No.: US 2026/0226964 A1
(43) Pub. Date: Aug. 6, 2026

(54) Sector gear drive mechanism for generating sweeping rotary motion about two perpendicular axes

(71) Applicant: VIETTEL GROUP, Ha Noi City (VN)

(72) Inventors: BAU NGUYEN, Ha Noi City (VN); THI HANG LE, Ha Noi City (VN); HOAI SON NGUYEN, Ha Noi City (VN); VAN TUNG NGUYEN, Ha Noi City (VN); XUAN BACH LUU, Hung Yen Province (VN); TAN LONG PHAM, Ha Noi City (VN); MINH VIEN NGUYEN, Ha Noi City (VN); TUAN ANH LA, Ha Noi City (VN)

(73) Assignee: VIETTEL GROUP, Ha Noi City (VN)

(21) Appl. No.: 19/453,304

(22) Filed: Jan. 20, 2026

(30) Foreign Application Priority Data
Jan. 22, 2025 (VN) 1-2025-00513

(51) Int. Cl. F16H 19/08

(52) U.S. Cl. CPC F16H 19/08

(57) ABSTRACT

The invention relates to a sector gear drive mechanism for generating sweeping rotary motion about two perpendicular axes for devices used in search, observation, and target tracking applications. The mechanism provides dual-axis rotary motion in a horizontal direction and a vertical direction and employs meshing dual-spring-loaded gear pairs as a transmission system. The mechanism comprises a horizontal channel assembly and a vertical channel assembly. Position sensors and angular velocity sensors are arranged and configured to optimize spatial layout and reduce overall mass of the mechanism.

### TECHNICAL FIELD

The invention relates to a mechanical drive mechanism for transmitting sweeping rotary motion about two perpendicular axes. More particularly, the invention relates to a sector gear drive mechanism capable of generating sweeping rotary motion about two mutually perpendicular axes, applicable to dual-axis drive systems for rotating and scanning devices in both horizontal and vertical directions.

### BACKGROUND OF THE INVENTION

Among published patent documents and technical publications, several solutions disclose dual-axis drive mechanisms for rotating and scanning devices. However, such solutions differ from the present invention in structure and operating principle.

For example, U.S. Pat. No. 6,531,990 B2, entitled “Satellite Antenna Scanning System” and issued on Mar. 11, 2003, discloses a mechanism for rotating a satellite antenna about elevation and azimuth axes. In one transmission direction, the mechanism employs spring-loaded gear pairs to generate sweeping rotary motion.

Although the above-mentioned patent provides a similar dual-axis scanning function, the sector gear drive mechanism disclosed herein differs entirely in terms of drive structure, mechanical configuration, and structural layout from the cited prior art.

Accordingly, to further clarify the above distinctions, the inventors propose a sector gear drive mechanism for generating sweeping rotary motion about two perpendicular axes for rotating and scanning devices, which is structurally and functionally distinct from any previously disclosed invention.

### BRIEF SUMMARY OF THE INVENTION

An object of the invention is to provide a detailed description of a sector gear drive mechanism capable of generating sweeping rotary motion about two perpendicular axes.

The mechanism utilizes motors in combination with spur gear transmissions to generate rotational motion and provide the required torque. In addition, meshing gear pairs employ dual-spring-loaded gears to reduce mechanical backlash in the gear transmission, thereby improving motion accuracy.

Furthermore, the output stages of the gear transmissions utilize gears with solid shafts, enabling accurate acquisition of angular position, rotational speed, and related parameters. By employing a shaft-support structural design, the sector gear drive mechanism optimizes spatial arrangement for accommodating auxiliary components such as angular velocity sensors and further optimizes the spatial layout of the gear transmission system.

To achieve one or more of the above objectives, the invention provides a sector gear drive mechanism for generating sweeping rotary motion about two perpendicular axes, comprising a horizontal channel assembly (1) and a vertical channel assembly (2).

Horizontal channel assembly (1) comprises:
a first horizontal transmission frame (3) and a second horizontal transmission frame (5);
a horizontal transmission cover (6);
a horizontal gear transmission assembly (4);
a damper;
a horizontal travel stop assembly (18);
an angular velocity sensor assembly (19).
   Vertical channel assembly (2) comprises:
a first vertical transmission frame (10) and a second vertical transmission frame (13);
a motor mounting frame (11);
a vertical transmission cover (7);
a vertical gear transmission assembly (8);
a position sensor assembly (16);
an angular velocity sensor assembly (17);
a vertical travel stop bracket (12).

All position sensors and angular velocity sensors are fixedly mounted on the output shafts of the mechanism and are securely mounted by aluminum alloy components.

The invention may be applied to rotating and scanning devices, observation systems, and search or tracking systems.

### BRIEF DESCRIPTION OF THE DRAWING

FIG. 1 is an overall perspective view of the mechanical structure of the invention;

FIG. 2 illustrates the constituent components of the sector gear drive mechanism;

FIG. 3 illustrates the horizontal channel gear assembly;

FIG. 4 illustrates the vertical channel gear assembly.

### DETAILED DESCRIPTION OF THE INVENTION

The invention comprises a horizontal channel assembly (1) and a vertical channel assembly (2). Each channel is independently driven by a corresponding motor assembly and a respective gear transmission assembly. Sensors are mounted on each output shaft to provide angular position and rotational speed data.

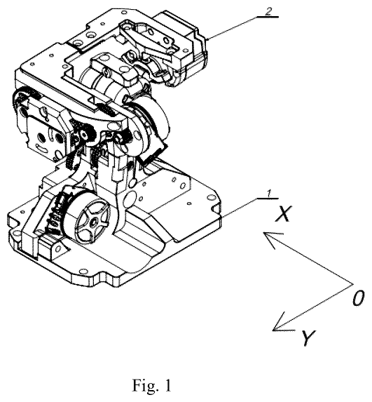

As illustrated in FIG. 1, the horizontal channel corresponds to an x-axis, and the vertical channel corresponds to a y-axis. The terms “horizontal channel” and “vertical channel” are used solely for descriptive purposes and are not intended to limit the scope of the invention.

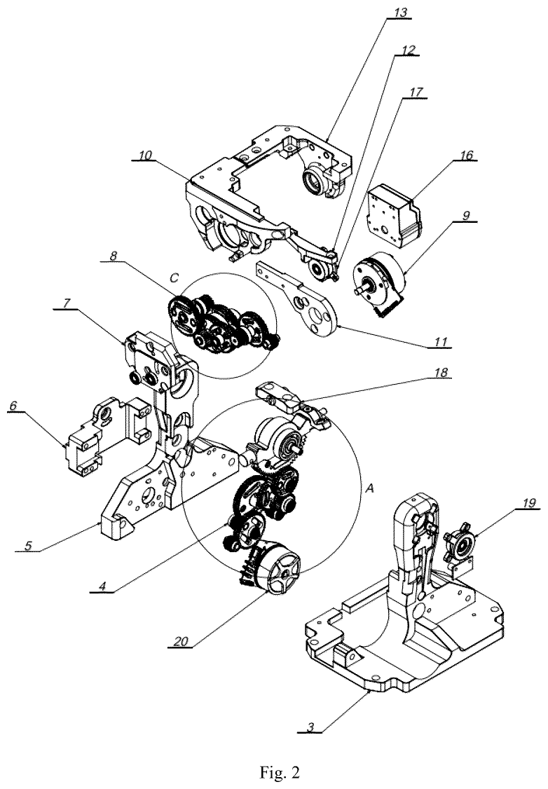

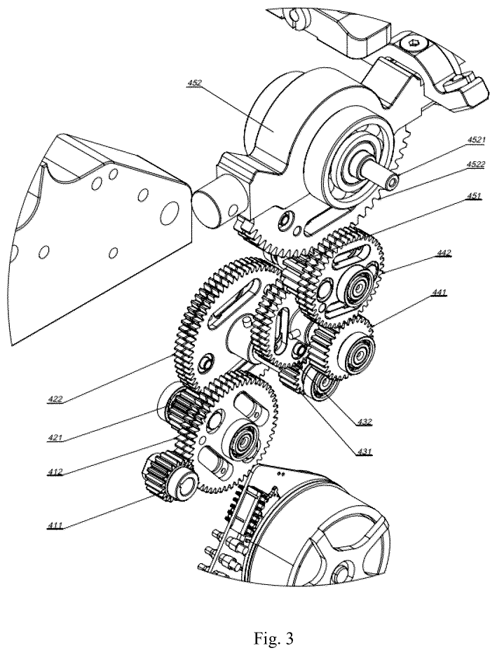

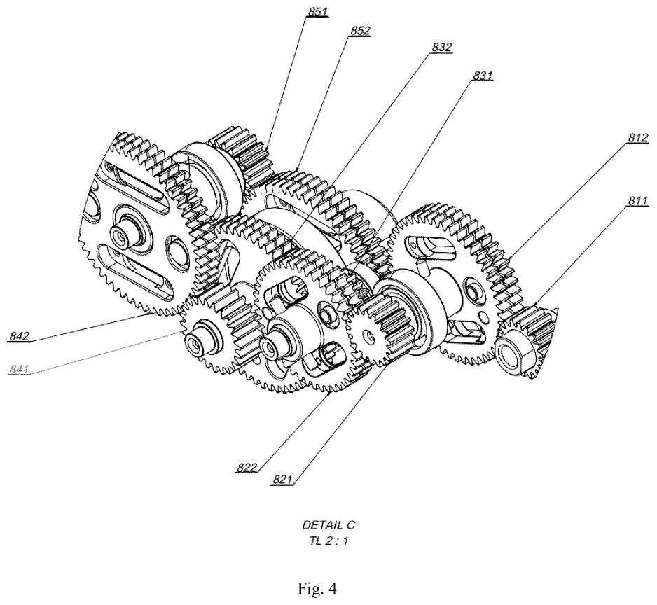

Referring to FIGS. 1-4, the sector gear drive mechanism comprises the following components.

### Horizontal Channel Assembly (1)

The horizontal channel assembly includes mechanical support frames, gears, a motor, and position sensors. Distinguishing features of the horizontal channel assembly include:

The first horizontal transmission frame (3) and the second horizontal transmission frame (5) are mechanical components made of aluminum alloy and are machined with a specific profile, wherein a lower portion is widened to increase base support area, and a body portion is tapered and hollowed to allow large sweeping angles without mechanical interference during operation. The transmission frames also serve to mount meshing gear pairs, the motor, and position sensors.

The horizontal transmission cover (6) is made of aluminum alloy and is configured to mount the meshing gear pairs and to protect the dual-spring-loaded horizontal gear transmission assembly (4) from dust and contaminants, thereby ensuring stable gear meshing.

The position sensor assembly (19) includes a position sensor and a mounting bracket made of aluminum alloy.

The horizontal gear transmission assembly (4) comprises five gear stages, including meshing dual-spring-loaded gear pairs (411, 412), (421, 422), (431, 432), (441, 442), and (451, 452), arranged sequentially throughout the horizontal channel assembly from the base portion to the upper portion of the transmission frames. Gear (411) is directly coupled to the horizontal motor (20), and gear (452) is coupled to the vertical channel assembly (2). When the horizontal motor (20) rotates, gear (411) transmits motion to the vertical channel assembly through the meshing gear pairs of the horizontal gear transmission assembly (4).

Gear (452) comprises two portions: a shaft portion (4521) coaxially mounted with the position sensor assembly (19) to determine the angular position of the vertical channel assembly during horizontal rotation, and a gear portion (4522) configured to mesh with gear (451).

A damper (15) is a standard mechanical component used to reduce shock and limit travel when the mechanism reaches end positions, thereby reducing impact and vibration.

The horizontal travel stop (18) is made of stainless steel and is configured to mount the damper, forming a travel stop assembly that prevents mechanical collision during operation.

### Vertical Channel Assembly (2)

The vertical channel assembly includes mechanical components, a vertical gear transmission assembly, and position sensors for mounting and rotating the scanning payload. Distinguishing features of the vertical channel assembly include:

The first vertical transmission frame (10) and the second vertical transmission frame (13) are mechanical components made of stainless steel and configured to mount the dual-spring-loaded vertical gear transmission assembly and the position and angular velocity sensors.

The motor mounting frame (11) is made of aluminum alloy and is configured to mount and position the vertical motor and the vertical gear transmission assembly.

The vertical gear transmission assembly (8) comprises five gear stages and is specially designed with two shaft-support gear groups to optimize transmission space. The assembly includes meshing gear pairs (811, 812), (821, 822), (831, 832), (841, 842), and (851, 852). Gear (811) is coupled to the vertical motor (9), and output gear (852) is coupled to the vertical channel assembly (2). When the vertical motor rotates, gear (811) transmits motion to the vertical channel assembly through the meshing gear pairs.

The vertical transmission cover (7) is made of stainless steel and is configured to mount bearings, ensure accurate center distances between meshing gear pairs, and partially shield the vertical gear transmission assembly from dust and contaminants.

The position sensor assembly (16) includes a position sensor and an aluminum alloy mounting housing and is mounted on the vertical channel to determine the angular position of the drive mechanism along both axes.

The angular velocity sensor assembly (17) includes an angular velocity sensor and an aluminum alloy mounting bracket and is arranged within the second vertical transmission frame (13) to optimize sweeping space.

The vertical travel stop bracket (12) is made of stainless steel and is configured to limit the sweeping travel of the vertical channel and reduce shock when the vertical channel reaches maximum angular positions.

Motors (9, 20) are commercially available electromagnetic components configured to generate rotational motion for the horizontal and vertical channels, respectively.

The horizontal channel assembly (1) and the vertical channel assembly (2) are interconnected via gear (452) of the horizontal channel assembly.

Through the described configuration, the motors transmit motion through the horizontal gear transmission assembly (4) to generate sweeping rotary motion of the horizontal channel. Bearings and intermediate gear stages increase output torque while optimizing transmission space. Angular velocity information is obtained from sensor assembly (19) mounted directly on the horizontal output shaft to facilitate motion control.

For the vertical channel, the specially designed shaft-support gear structure of the vertical gear transmission assembly (8) optimizes transmission space and increases sweeping angle range. The arrangement of the position sensor assembly (16), angular velocity sensor assembly (17), and counterweight (9) enables precise control and reduces external torque effects during operation.

The counterweight (9), made of stainless steel, is designed with various profiles to allow mounting at different positions, thereby adjusting the center of mass of the vertical transmission assembly toward the rotation axis without affecting the sweeping radius.

By optimizing spatial arrangement, the mechanism achieves a reduced sweeping diameter and compact overall dimensions suitable for space-constrained systems.

Additionally, mechanical components made of aluminum alloy 6061-T6 are designed with stepped structures and reinforcing ribs and are hard-anodized to enhance scratch resistance, aesthetics, and weight optimization. Gears, shafts, and mechanical stops are made of stainless steel materials SUS420J2 and SUS304. The gears are surface-hardened to ensure high surface hardness and durability, thereby reducing wear during operation.

1. A sector gear drive mechanism for generating sweeping rotary motion about two perpendicular axes, comprising:
a horizontal channel assembly;
a first horizontal transmission frame and a second horizontal transmission frame made of aluminum alloy and machined with a specific profile, wherein a lower portion is widened to increase base area, and a body portion is tapered and hollowed to allow large sweeping angles without mechanical interference, the transmission frames being configured to mount meshing gear pairs, a motor, and position sensors;
a horizontal gear transmission assembly comprising five gear stages including first, second third, fourth and fifth meshing gear pairs arranged sequentially from a base portion to an upper portion of the horizontal channel assembly, wherein a first gear of the first gear pair is directly coupled to a horizontal motor and a second gear of the fifth gear pair is coupled to a vertical channel assembly, such that rotation of the horizontal motor is transmitted to the vertical channel assembly through the meshing gear pairs;
wherein the second gear of the fifth gear pair comprises a shaft portion coaxially mounted with a position sensor assembly for determining angular position of the vertical channel assembly during horizontal rotation, and a gear portion configured to mesh with the first gear of the first gear pair;
a vertical channel assembly comprising mechanical components, a vertical motor, and a vertical gear transmission assembly configured to generate motion along a vertical channel;
wherein the vertical gear transmission assembly comprises five gear stages including including first, second third, fourth and fifth meshing gear pairs, and is configured with two shaft-support gear groups to optimize transmission space, wherein a first gear of the first meshing gear pair is directly coupled to the vertical motor and a second gear of the fifth meshing gear pair is coupled to the vertical channel assembly;
and a vertical transmission cover made of stainless steel and configured to mount bearings, ensure accurate center distances between meshing gear pairs, and partially shield the vertical gear transmission assembly from contaminants;
wherein the motor is a compact DC motor configured to generate rotary motion of the vertical channel assembly.

2. The sector gear drive mechanism according to claim 1, wherein the horizontal channel assembly and the vertical channel assembly are interconnected via a gear of the horizontal channel assembly.

3. The sector gear drive mechanism according to claim 1, wherein mechanical components made of aluminum alloy 6061-T6 are formed with stepped structures and reinforcing ribs and are hard-anodized, and wherein gears, shafts, and mechanical stops are made of stainless steel materials SUS420J2 and SUS304, and the gears are surface-hardened to enhance durability and reduce wear during operation.
